(19) United States
(12) Patent Application Publication
(10) Pub. No.: US 2015/0108673 A1
(43) Pub. Date: Apr. 23, 2015

(54) IMPRINTING APPARATUS AND METHOD FOR IMPRINTING

(71) Applicant: The Chinese University of Hong Kong, Hong Kong (CN)

(72) Inventors: Shih-Chi Chen, Hong Kong (CN); Jianwei Chen, Hong Kong (CN); Jiyi Cheng, Hong Kong (CN)

(73) Assignee: The Chinese University of Hong Kong, Hong Kong (CN)

(21) Appl. No.: 14/057,314

(22) Filed: Oct. 18, 2013

(51) Int. Cl. B29C 59/02; B29C 59/00

(52) U.S. Cl. CPC B29C 59/02; B29C 59/002; B29C 2059/023
USPC 264/40.5; 425/149; 425/385

(57) ABSTRACT

A micro-contact imprinting apparatus for transferring patterns of a stamp to a substrate.

### TECHNICAL FIELD

The present application relates to a micro-contact imprinting apparatus for transferring patterns of a stamp to a substrate and a method for imprinting the patterns onto the substrate.

### BACKGROUND

Patterning micro-lens array on curved surfaces, which are well known as artificial compound eyes, are widely used in wide field-of view imaging and sensing system. Building a spherical compound eye requires the ability to pattern compact and uniformity micro-lens array on curved surfaces, which is a technique challenge to fabricate these structures. One possible approach is to use the laser lithographic technique, directly writing onto the spherical substrate, which is fixed on a smart positioning strategy with six degrees of freedom, but this technology is extremely time-consuming and only able to fabricate micro-lens in spherical shape. Recently, a different method for manufacturing micro-lens array on lens substrate was proposed; this method replicates micro-lens array on a flat PMMA film and subsequently bonds it to a glass cap by thermal extrusion process. This process yields high quality micro-lenses, but a planar PMMA film cannot make conformal contact with curved surfaces; consequently, it can only be used in small area patterning. Other techniques such as the sol-gel process and reconfigurable microtemplating can pattern micro-lens array on curved surfaces; however, none of these technologies can print uniform micro-lens array over large surfaces on substrates of various curvatures at low cost.

### SUMMARY

The application is proposed to develop a micro-contact imprinting apparatus for transferring patterns of a stamp to a substrate and a method for imprinting the patterns onto the substrate.

In one aspect, the apparatus comprises an enclosure and an air-pressure device. The enclosure may be divided into a first chamber and a second chamber. The first chamber and the second chamber air-tightly are isolatable with each other by the stamp, wherein the substrate is arranged in the second chamber. The air-pressure device is configured to be fluidly connected with the first chamber and the second chamber so as to generate air-pressure differences between the first chamber and the second chamber such that the generated air-pressure differences make the patterns transferred from the stamp to the substrate when the stamp contacts the substrate.

In another aspect, the method is utilized for imprinting patterns of a stamp onto a substrate by means of a micro-contact imprinting apparatus, wherein the apparatus comprises an enclosure and an air-pressure device fluidly connected with the enclosure, and the method comprises a step of installing the stamp inside the enclosure to divide the enclosure into a first chamber and a second chamber; a step of mounting the substrate in the second chamber in alignment with the stamp; and a step of controlling the air-pressure device to generate air-pressure differences between the first chamber and the second chamber such that the generated air-pressure differences make the patterns transferred from the stamp to the substrate.

### BRIEF DESCRIPTION OF THE DRAWINGS

The drawings described herein are used to provide a further understanding to the present application and constitute a part of this specification. Exemplary embodiments of the present application and their descriptions serve to explain the present application and do not constitute improper limitations on the present application. In the drawings:

FIG. 1 illustrates a micro-contact imprinting apparatus for transferring patterns of a stamp to a substrate according to one embodiment of the present application;

FIG. 2 illustrates diagrams for applying different cyclic pressure loadings during imprinting processes that helps remove impurities such as air bubbles;

FIG. 3 illustrates a flowchart for a method for imprinting patterns of the stamp onto the substrate by means of the micro-contact imprinting apparatus according to an embodiment of the present application.

### DETAILED DESCRIPTION

Hereinafter, the present application will be explained in detail with reference to the accompanying drawings in connection with embodiments thereof

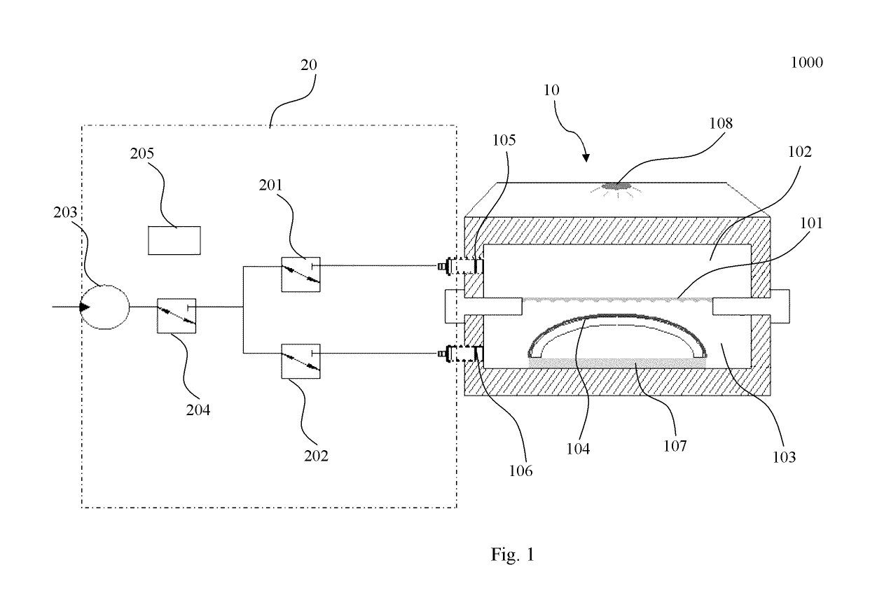

FIG. 1 illustrates a micro-contact imprinting apparatus 1000 for transferring patterns of a stamp to a substrate according to one embodiment of the present application. In one embodiment, the patterns may be micro lens array formed by soft UV imprint techniques. To be specific, the PDMS mixture is spin-cast to the master substrate and then is cured to form the membrane (stamp). Next, the UV-curable resin (NOA 61) is spin-cast onto a base, and pre-cured by exposing to UV lamp in air for about 2 minutes. This simple pre-cure process helps prevent the resist from being absorbed into the PDMS stamps and allows high resolution pattern transfer during the soft imprint process. Lastly, the stamp is imprinted onto the substrate and exposed to UV light at the same time. Finally, the stamp is removed and the micro-lens array is formed.

As shown in FIG. 1, the apparatus 1000 may comprise an enclosure 10 and an air-pressure device 20. The enclosure 10 may be divided by the stamp 101 into two chambers, i.e. a first chamber 102 and a second chamber 103. The first chamber 102 and the second chamber 103 are air-tightly isolatable with each other by the stamp 101. As shown, a substrate 104 is arranged in the second chamber 103.

The air-pressure device 20 is configured to be fluidly connected with the first chamber 102 and the second chamber 103 so as to generate air-pressure differences between the first chamber 102 and the second chamber 103 such that the generated air-pressure differences make the patterns transferred from the stamp 101 to the substrate 104 when the stamp contacts the substrate.

Referring to FIG. 1 again, the air-pressure device 20 may comprise two air controlling branches, i.e. a first branch consisting of a first valve 201 and a second branch consisting of a second valve 202. The first branch communicates with the first chamber 102 through an opening 105 formed in the first chamber 102. The second branch communicates with the second chamber 103 through an opening 106 formed in the first chamber 103.

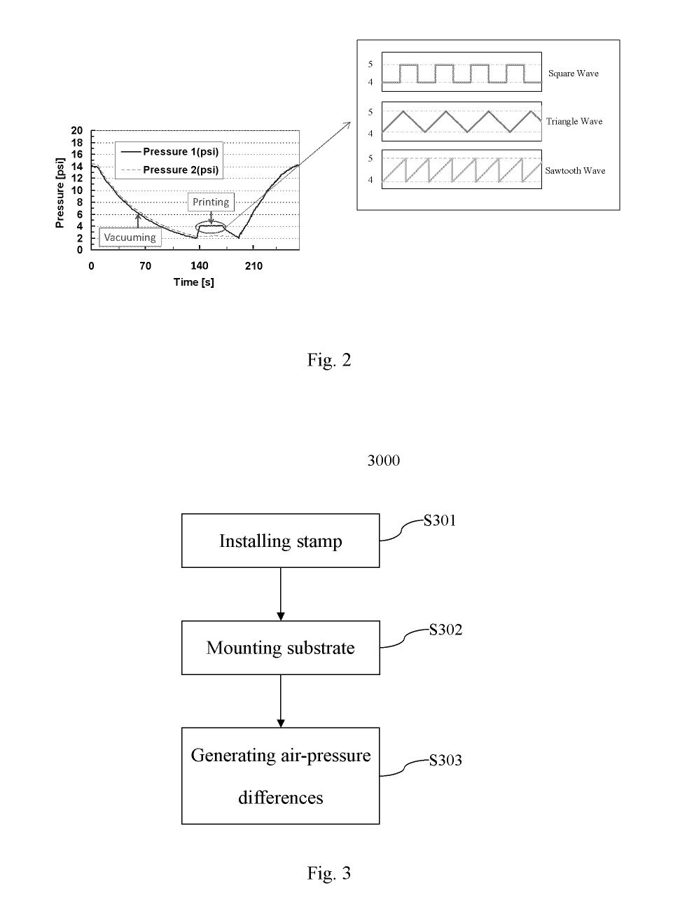

The air-pressure device 20 may further comprise a vacuum pump 203 and a third valve 204. The first and the second and the third valves are controllable to be fluidly connected with the vacuum pump 203 and the first and second chambers so as to separately control respective air pressures in the first chamber 102 and the second chamber 103 to generate the air-pressure differences. In particular, there will be a controller 205 arranged in the air-pressure device 20 and one or more load cells 107 arranged within the second chamber 103 for sensing a load on the substrate. The controller 205 may be an air pressure gauge. The controller 205 is configured to receive a parameter for the sensed load and then, in response to the received parameter, separately control respective air pressures in the first chamber 102 and the second chamber 103 so as to apply the cyclic load in form of wave onto the substrate, such that air bubbles trapped between the membrane and the substrate and/or impurities such as small particles could be removed by the resulted cyclic pressure loadings. The wave may be one selected from a group consisting of a square wave, a triangle wave, or a sawtooth wave, as shown in FIG. 2.

In particular, the controller 205 controls the third valve 204 to switch from one position to another position such that the vacuum pump 203 removes the air in the first chamber 102 and the second chamber 103 through the first branch and the second branch, respectively, to generate vacuum in the both chambers. With vacuum in the chambers, a higher air-pressure difference can be obtained by the air pressure to be applied later in the chambers. And then the controller 205 controls the third valve 204 to switch such that the vacuum pump 203 may increase an air-pressure in the first chamber 102 and the increased the air-pressure press the stamp 101 to move and contact with the substrate 104. The controller 205 increases an air-pressure in the second chamber 103 to separate the stamp 101 from the substrate, leaving the patterns in the substrate. It shall be appreciated that the first, the second and the third valves operate to switch in accordance with the hydrokinetics principle as well known in the art.

Though the substrate in the second chamber as shown in FIG. 1 is curved, the patterns can also be transferred to a substrate with planar surfaces with the apparatus according to the present application.

In one embodiment, the apparatus 1000 may further comprise a UV light source 108 arranged on top of the enclosure 10 for curing the transferred patterns.

Hereinafter, a method 3000 for imprinting patterns of the stamp onto the substrate by means of the micro-contact imprinting apparatus with the enclosure as above will be discussed. In particular, in step S301, the stamp is installed inside the enclosure such that the enclosure is divided into a first chamber and a second chamber. The first chamber and the second chamber are air-tightly isolatable with each other by the stamp and the substrate is arranged in the second chamber.

In step S302, the substrate is mounted in the second chamber so as to be in alignment with the stamp. And then in step S303, the air-pressure device operates to generate air-pressure differences between the first chamber and the second chamber such that the generated air-pressure differences make the patterns transferred from the stamp to the substrate. To be specific, the controlling may be implemented by controlling the air-pressure device to removes air in the first chamber and the second chamber so as to generate vacuum in both the chambers, increasing an air-pressure in the first chamber so as to make the stamp contacted with the substrate, and increasing an air-pressure in the second chamber so as to separate the stamp from the substrate, leaving the patterns in the substrate.

In addition, in the step of increasing an air-pressure in the second chamber, one or more loads cells may sense a load from the air pressures and on the substrate, and the air pressures in the first chamber and the second chamber may be separately controlled so as to apply the load in different forms of wave onto the substrate in response to the received parameter.

In one embodiment, the method 2000 may comprises a step of measuring radii of the substrate, a step of calculating, based on the measured radii, extension ratios of the stamp, and step of determining compensation ratios and then determining a layout of patterns based on the compensation ratios. Taking the patterns as the micro-lens array curved surfaces again, the stamp (for example PDMS membrane) will be pressurized to imprint on the curved substrate coated with UV curable resin. To ensure a conformal contact between the stamp 101 and the spherical substrate 104, the flexible PDMS membrane needs to undergo large deformation (for example, 2×), which results in distorted patterns. To eliminate the distortions, distortion correction algorithm has been applied in the mask design (by calculating and compensating the extension ratios in longitudinal and latitudinal directions for micro-lens in a specific radius). Using this approach, a distortion-corrected hexagonal grid pattern mask was fabricated. To demonstrate this capability, a distortion-corrected membrane was used to pattern micro-lens array on a spherical substrate, forming the image of characters.

The apparatus and the method according to the present application are described as above in connection with transferring patterns on to a substrate of UV curable epoxies. However, with the apparatus and the method according to the present application can also be used for transferring all kinds of different materials (patterns) on curved or flat substrates. For example, thiols (SAMs), as one of patterns, can be transferred to scale up Micro-contact Printing, or quantum dots or even DNAs can also be transferred on substrates for biological studies.

In addition, the apparatus and the method according to the present application can also be used in implementing various nanometer resolution printing techniques, such as, besides UV imprint, hot embossing, and soft lithography.

In one embodiment of the present application, air bubbles and arrays of cavities will have range of dynamic physical effects on micro-lens forming on thin polymer films during the soft UV imprint process, including capillary action, trapping of air and viscous phenomenon. Although both chambers are vacuumed before the imprint process, some air bubbles cannot be totally avoided to be trapped between the membrane and the substrate, which negatively affects imprint quality. Fortunately, the apparatus according to the present application allows precise control of the pressure difference between the two chambers; accordingly the application specific loading waves (e.g. square wave, triangle wave and sawtooth wave etc.) helps remove the trapped air bubble during the imprint process. To summarize, the apparatus has the following advantages: (1) air will not be trapped in small grooves of the stamp, (2) small particles can be largely removed from the bottom (printing) chamber before/during the printing process, (3) the controlled top chamber pressure on the elastomer stamp may minimize minor defects on the stamp or the particle-trapping effect.

With the apparatus according to the present application micro-lens array can be imprinted on a flat surface with great precision (e.g. 100s nanometers) and repeatability. To avoid the membrane deformation problem when printing on flat substrates, a thick PDMS stamp (e.g. 1-2 mm) can be bonded to the center portion of the membrane before/during the imprinting process; this ensures minimized distortions in the center region of the stamp.

Features, integers, characteristics, or combinations described in conjunction with a particular aspect, embodiment, implementation or example disclosed herein are to be understood to be applicable to any other aspect, embodiment, implementation or example described herein unless incompatible therewith. All of the features disclosed in this application (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments and extends to any novel one, or any novel combination, of the features disclosed in this specification (including any accompanying claims, abstract and drawings), or to any novel one, or any novel combination, of the steps of any method or process so disclosed.

What is claimed is:

1. A micro-contact imprinting apparatus for transferring patterns of a stamp to a substrate, comprising:
an enclosure dividable into a first chamber and a second chamber by the stamp, the first chamber and the second chamber being air-tightly isolatable with each other by the stamp, wherein the substrate is arranged in the second chamber; and
an air-pressure device configured to be fluidly connected with the first chamber and the second chamber to generate air-pressure differences between the first chamber and the second chamber, such that the generated air-pressure differences push the stamp to move and contact with the substrate so as to enable the patterns to be transferred from the stamp to the substrate when the stamp contacts the substrate.

2. The micro-contact imprinting apparatus of claim 1, wherein the air-pressure device comprises:
a vacuum pump; and
a plurality of valves controllable to be fluidly connected with the vacuum pump and the first and the second chambers so as to separately control respective air pressures in the first chamber and the second chamber to generate the air-pressure differences.

3. The micro-contact imprinting apparatus of claim 2, wherein a vacuum is created in any of the first and second chambers.

4. The micro-contact imprinting apparatus of claim 2, further comprising:
one or more load cells arranged within the second chamber for sensing an air pressure load on the substrate; and
wherein the air-pressure device comprises one or more controller configured to receive a parameter for the sensed load, and, in response to the received parameter, separately control respective air pressures in the first chamber and the second chamber so as to apply the load in form of wave onto the substrate .

5. The micro-contact imprinting apparatus of claim 4, wherein the one or more load cells are arranged at the bottom of the second chamber.

6. The micro-contact imprinting apparatus of claim 4, wherein the wave may be one selected from a group consisting of a square wave, a triangle wave, or a sawtooth wave.

7. The micro-contact imprinting apparatus of claim 4, further comprising a UV light source arranged on top of the enclosure for curing the transferred patterns.

8. The micro-contact imprinting apparatus of claim 4, wherein the controller comprises an air pressure gauge.

9. A method for imprinting patterns of a stamp onto a substrate by means of a micro-contact imprinting apparatus, wherein the apparatus comprises an enclosure and an air-pressure device fluidly connected with the enclosure, and the method comprises:
installing the stamp inside the enclosure to divide the enclosure into a first chamber and a second chamber;
mounting the substrate in the second chamber in alignment with the stamp; and
controlling the air-pressure device to generate air-pressure differences between the first chamber and the second chamber such that the generated air-pressure differences push the stamp to move and contact with the substrate so as to enable the patterns to be transferred from the stamp to the substrate when the stamp contacts the substrate.

10. The method of claim 9, wherein the controlling comprises:
controlling the air-pressure device to remove air in the first chamber and the second chamber so as to generate vacuum in both the chambers;
increasing air-pressure in the first chamber so as to deform the stamp and the stamp makes conformal contact with the substrate; and
increasing an air-pressure in the second chamber so as to separate the stamp from the substrate, leaving the patterns in the substrate.

11. The method of claim 9, wherein the step of increasing an air-pressure in the second chamber further comprises:
sensing a load on the substrate; and
separately controlling respective air pressures in the first chamber and the second chamber so as to apply the load in form of wave onto the substrate in response to the received parameter.

12. The method of claim 11, further comprising curing the transferred patterns.

13. The method of claim 9, further comprising:
measuring radii of the substrate;
calculating, based on the measured radii, extension ratios of the stamp;
determining compensation ratios; and
determining a layout of patterns based on the compensation ratios.

14. The method of claim 11, wherein the patterns comprise thiols, quantum dots, or DNAs.

15. A micro-contact imprinting apparatus for transferring patterns of a stamp to a substrate, comprising:
an enclosure dividable into a first chamber and a second chamber by the stamp, the first chamber and the second chamber being air-tightly isolatable with each other by the stamp, wherein the substrate is arranged in the second chamber; and
an air-pressure device configured to be fluidly connected with the first chamber and the second chamber so as to:
remove air in the first chamber and the second chamber to generate vacuum in the both chambers;
increase air-pressure in the first chamber to make the stamp in contact with the substrate; and
increase air-pressure in the second chamber to separate the stamp from the substrate, leaving the patterns in the substrate.

16. The micro-contact imprinting apparatus of claim 15, further comprising:
one or more load cells arranged within the second chamber for sensing a load on the substrate; and
wherein the air-pressure device comprises one or more controller configured to receive a parameter for the sensed load, and, in response to the received parameter, separately control respective air pressures in the first chamber and the second chamber so as to apply the load in form of wave onto the substrate .

17. The micro-contact imprinting apparatus of claim 15, further comprising a UV light source arranged on top of the enclosure for curing the transferred patterns.
